(19) United States
(12) Patent Application Publication
(10) Pub. No.: US 2026/0195798 A1
(43) Pub. Date: Jul. 9, 2026

(54) INFORMATION PROCESSING DEVICE

(71) Applicant: TOYOTA JIDOSHA KABUSHIKI KAISHA, Toyota-shi (JP)

(72) Inventor: Yuma ISHINO, Tokyo (JP)

(73) Assignee: TOYOTA JIDOSHA KABUSHIKI KAISHA, Toyota-shi (JP)

(21) Appl. No.: 19/407,637

(22) Filed: Dec. 3, 2025

(30) Foreign Application Priority Data
Jan. 6, 2025 (JP) 2025-001986

(51) Int. Cl. G06Q 30/0601; G10L 15/18; G10L 15/22

(52) U.S. Cl. CPC G06Q 30/0617; G10L 15/18; G10L 15/22

(57) ABSTRACT

An information processing device uses a first phrase indicating a request of a customer included in speech of business negotiations with the customer, sent from a terminal device, and information of attributes of the customer, to cause an interactive AI to output information for presenting a response to the customer, and sends the information to the terminal device.

### CROSS-REFERENCE TO RELATED APPLICATION

This application claims priority to Japanese Patent Application No. 2025-001986 filed on January 6, 2025. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

Dialogue systems that automatically provide answers to given questions are known. For example, Japanese Unexamined Patent Application Publication No. 2023-076413 (JP 2023-076413 A) discloses technology for generating a domain-specific conversational bot based on documents in a given domain, using a large language model.

### SUMMARY

There has been room for improvement in accuracy of dialogue systems that automatically answer questions by using natural language processing and so forth using feature selection.

In view of the above circumstances, an object of the present disclosure is to improve the accuracy of dialogue systems that automatically provide answers to questions.

An information processing device according to an embodiment of the present disclosure includes a communication unit that communicates with a terminal device, and a control unit that performs communication using the communication unit, in which the control unit uses a first phrase indicating a request of a customer included in speech of business negotiations with the customer sent from the terminal device, and information of attributes of the customer, to cause an interactive AI to output information for presenting a response to the customer, and sends the information to the terminal device.

According to the embodiment of the present disclosure, accuracy of a dialogue system that automatically answers questions is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of an information processing device according to the present disclosure; and

FIG. 2 is a flowchart showing operations of the information processing device according to the present disclosure.

### DETAILED DESCRIPTION OF EMBODIMENTS

An embodiment of the present disclosure will be described below.

### Overview of Embodiment

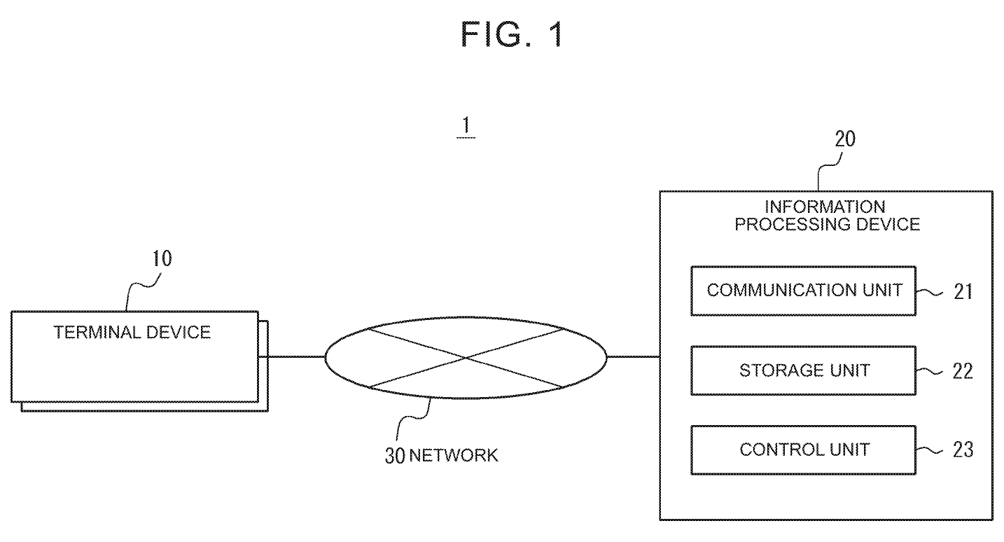

An overview of an information processing system 1 according to an embodiment of the present disclosure will be described with reference to FIG. 1. The information processing system 1 makes up a dialogue system that supports business negotiations between salespersons of vehicles and the like and customers, for example. The information processing system 1 includes one or more each of terminal devices 10 and information processing devices 20. The terminal device 10 and the information processing device 20 are communicably connected to a network 30 including, for example, the Internet, a mobile communication network, and so forth.

The terminal device 10 is, for example, a computer such as a personal computer (PC), a smartphone, a tablet terminal, or the like. The terminal device 10 is a computer used by, for example, a salesperson at a vehicle dealership when talking with a customer.

The information processing device 20 is, for example, one or a plurality of server computers that can communicate with each other. The information processing device 20 is capable of communicating information with each of the terminal devices 10 via the network 30. The information processing device 20 provides services that are used by, for example, salespersons at a shop such as a vehicle dealership or the like.

The information processing device 20 uses a first phrase (hereinafter referred to as “request phrase”) indicating a request of the customer contained in the speech of the business negotiations with the customer, which is sent from the terminal device 10, and information of attributes of the customer, to cause interactive artificial intelligence (AI) to output information for presenting a response to the customer (hereinafter referred to as “response information”), and sends the response information to the terminal device 10.

The information processing device 20 creates a prompt to be input to the interactive AI, using the request phrase indicating the request of the customer contained in the speech in the business negotiations with the customer, and the information of attributes of the customer. Accordingly, when having the interactive AI to answer a question regarding a recommended car model, for example, information such as the gender, age, family makeup, and so forth, of the customer can also be provided. Thus, the likelihood that an appropriate recommended car model, reasons thereof, and so forth, can be presented to the customer, is higher as compared to simply presenting an answer to a question. Accordingly, according to the present embodiment, when a question is input to the interactive AI, information of attributes of the customer is also provided, which raises the likelihood that the interactive AI will be able to output an appropriate answer to the question, thereby improving the accuracy of the dialog system that automatically answers questions.

Next, the configurations of the information processing system 1 will be described.

### Configuration of Information Processing Device

As illustrated in FIG. 1, the information processing device 20 includes a communication unit 21, a storage unit 22, and a control unit 23.

The communication unit 21 includes one or more communication interfaces that connect to the network 30. The communication interfaces support, for example, mobile communication standards, wired local area network (LAN) standards, or wireless LAN standards, but is not limited to these, and may support to any communication standard. The information processing device 20 communicates with each of the terminal devices 10 via the communication unit 21 and the network 30.

The storage unit 22 includes one or more memory devices. Each of the memory devices included in the storage unit 22 may function as, for example, a main storage device, an auxiliary storage device, or cache memory. The storage unit 22 stores any information used in operations of the information processing device 20. For example, the storage unit 22 may store system programs, application programs, embedded software, and the like. The storage unit 22 may store an interactive AI.

The control unit 23 includes one or more processors, one or more programmable circuits, one or more dedicated circuits, or a combination thereof. The processor may be, for example, a general-purpose processor such as a central processing unit (CPU), a graphics processing unit (GPU), or the like, or a dedicated processor specialized for particular processing, but is not limited thereto. The programmable circuit is, for example, a field-programmable gate array (FPGA), but is not limited thereto. The dedicated circuit is, for example, an application specific integrated circuit (ASIC), but is not limited thereto. The control unit 23 controls the overall operation of the information processing device 20.

### Operation Flow of Information Processing Device

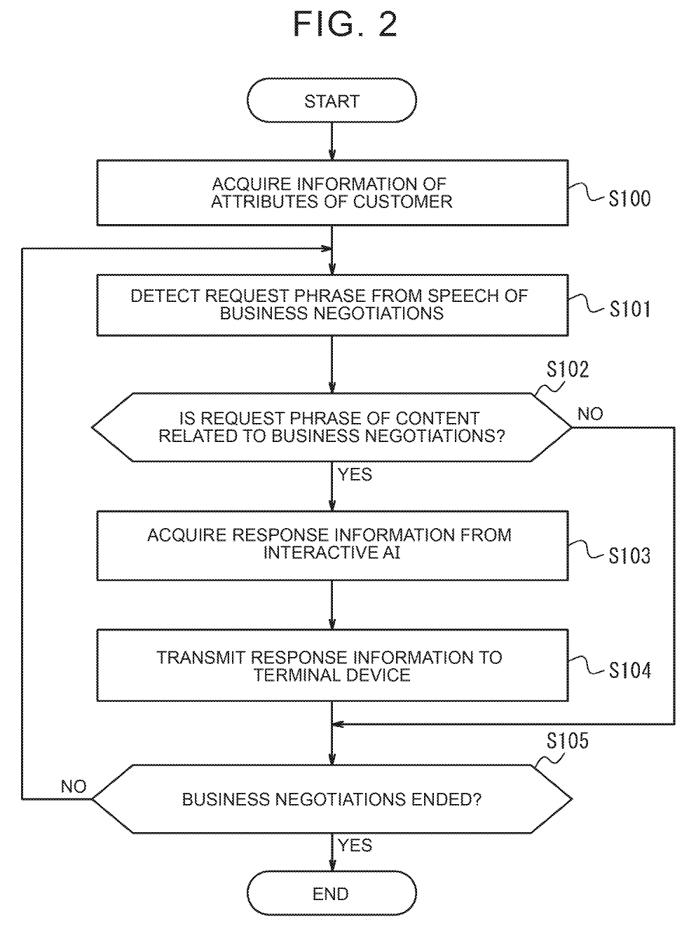

The operations of the information processing device 20 according to the present embodiment will be described with reference to FIG. 2. Each step in FIG. 2 is a step in information processing executed by the control unit 23 of the information processing device 20. Procedures in FIG. 2 are executed in response to an operation performed at the terminal device 10 by a salesperson when the salesperson is in business negotiations with a customer, for example.

S100: The control unit 23 of the information processing device 20 acquires information of attributes of the customer. Attributes of the customer include the gender, age, and family makeup of the customer. For example, attributes of the customer may include the number of customers who visit the shop. The control unit 23 receives information of attributes of the customer input by the customer or the salesperson, using the terminal device 10 or the like, via the communication unit 21 over the network 30. For example, the customer may input the information of attributes of the customer at a website where the customer can make a reservation to visit a shop, using a smartphone, personal computer (PC), or the like, owned by the customer. Alternatively, the salesperson may use a PC, such as the terminal device 10 or the like used by the salesperson to input information of attributes of the customer, based on contents of information collected from the customer in a visit to the shop, or contents of information from a questionnaire or the like that the customer fills out, or the like.

S101: The control unit 23 detects a request phrase from speech in the business negotiations. Specifically, the control unit 23 receives voice data of the business negotiations from the terminal device 10 over the network 30 via the communication unit 21. The terminal device 10 acquires the voice data using a microphone of the terminal device 10 or a microphone connected to the terminal device 10. Alternatively, the control unit 23 may receive the voice data directly from the microphone via the network 30 using the communication unit 21. The voice data is acquired at any cycle, such as every 10 milliseconds or the like, for example. The cycle at which the voice data is acquired may differ depending on performance of each device making up the information processing system 1, such as performance and so forth of the information processing device 20, for example. Next, the control unit 23 converts the voice data into text data using speech recognition technology. The control unit 23 then uses natural language processing to perform morphological analysis, syntactic analysis, semantic analysis, and contextual analysis, and thereby detects a request phrase. The request phrase is an expression in increments of words, idioms, or the like, or a sentence made up of a plurality of expressions. Alternatively, the request phrase may be a statement containing a plurality of sentences. For example, upon detecting a sentence such as "What car model is popular among people around my age group?" in the text data, the control unit 23 determines, through natural language processing, that the detected sentence indicates a request for a popular car model according to an age group, and detects that the sentence that has been detected is a request phrase.

The control unit 23 may also execute acquisition of information of attributes of the customer in S100 as part of S101. For example, the control unit 23 can use speaker separation processing to identify the utterer in the speech in the business negotiations, and acquire information of attributes based on the utterance of the customer in the speech. Specifically, the control unit 23 performs clustering with respect to the speech data of the business negotiations. Next, the control unit 23 uses speech data of the salesperson that is registered in advance, to identify which group of speech data, grouped by clustering, is speech data of the salesperson. Next, the control unit 23 identifies speech data other than that of the group that has been determined to be the speech data of the salesperson, as being speech data of the customer. Next, when converting the speech data into text data using speech recognition technology, the control unit 23 converts the data in a manner that enables distinguishing between utterances of the salesperson and utterances of the customer. The control unit 23 then acquires information of attributes of the customer from an utterance portion of the customer in the text data, using natural language processing. Alternatively, the control unit 23 may detect the name and so forth of the customer from the speech data of the business negotiations, and identify which group of speech data, grouped by clustering, that the speech data of the customer corresponds to. For example, the control unit 23 may identify a group calling the other person "Mr./Ms." from the speech data as being speech data of the salesperson, and identify other groups as being speech data of the customer. Acquisition of the information of attributes based on such speaker separation is also applicable when there is a plurality of customers. For example, when customer A and customer B are participating in business negotiations, the control unit 23 identifies the group using the title "Mr./Ms." in the speech data as the being the speech data of the salesperson. Next, the control unit 23 identifies a group of the speech data generated after the salesperson calls the customer "Mr./Ms. A" as being speech data of customer A, and identifies a group of the speech data generated after the salesperson calls the customer "Mr./Ms. B" as speech data of customer B. The control unit 23 then uses natural language processing to acquire information of attributes of each of customer A and customer B, from utterance portions by customer A and customer B in the text data.

S102: The control unit 23 determines whether the request phrase that is detected is related to business negotiations. For example, when the request phrase contains a preset keyword stored in the storage unit 22, the control unit 23 determines that the request phrase is related to business negotiations. For example, when a keyword "car" is set, and the request phrase is "What car model is popular among people around my age group?" the control unit 23 determines the request phrase to be related to business negotiations since the keyword “car” is included, and when the request phrase is "May I have some tea?" the control unit determines the request phrase to not be related to business negotiations since the keyword “car” is not included. When the request phrase is related to business negotiations (Yes in S102), the control unit 23 advances to S103, and when the request phrase is not related to business negotiations (No in S102), advances to S105.

S103: The control unit 23 uses the request phrase and the information of attributes of the customer to cause the interactive AI to output response information. Specifically, the control unit 23 generates a prompt to be input to the interactive AI using the request phrase and information of attributes of the customer, which is then input to the interactive AI. The control unit 23 then acquires the response from the interactive AI to the prompt that is input, as response information. Note that the control unit 23 may use the interactive AI stored in the storage unit 22, or may use an interactive AI provided by another server or the like. For example, when detecting a request phrase related to business negotiations such as "What car model is popular with people around my age group?" in S102, the control unit 23 generates a prompt in which the sentence, "Please answer about a car model that is likely to be preferred by the customer, taking into consideration the prior information below," followed by a phrase indicating the attributes of the customer, such as for example, "The customer is 39 years old, male, and single," and inputs the prompt to the interactive AI. Also, templates can be used to generate prompts. For example, a template may be used in which the sentence, "This is a scene in which a staff member and a customer are in business negotiations over a vehicle. Please answer the customer's questions below," followed by a request phrase, and then the sentence, "However, please answer taking into consideration that the customer has the following attributes," followed by a phrase indicating the information of attributes of the customer added thereto.

When there are multiple customers, the control unit 23 may identify the customer who uttered the request phrase in S101, and use the information of attributes of the customer who is identified to cause the interactive AI to output response information. For example, upon detecting a request phrase regarding business negotiations from the speech data of a customer, the control unit 23 uses information of attributes of the customer to generate a prompt to be input to the interactive AI, which is then input to the interactive AI.

S104: The control unit 23 sends the response information to the terminal device 10 over the network 30 via the communication unit 21. The terminal device 10 displays the response information on a display of the terminal device 10. The salesperson uses the response information to respond to the customer.

S105: The control unit 23 determines whether the business negotiations have ended. For example, the control unit 23 may determine that the business negotiations have ended when no speech data is received from the terminal device 10 or a microphone installed in the shop for a predetermined amount of time or longer. The predetermined time is optionally set within a range of, for example, 60 to 300 seconds. Alternatively, the control unit 23 may determine that the business negotiations have ended by receiving information from the terminal device 10 indicating that the business negotiation has ended, for example. Specifically, when the salesperson presses a button related to the end of the business negotiations, for example, which is provided on the screen of the terminal device 10, the terminal device 10 transmits information indicating that the dialogue has ended to the information processing device 20. Upon receiving information indicating the end of the dialogue from the terminal device 10, the control unit 23 determines that the business negotiations have ended. When determination is made that the business negotiations have ended, the control unit 23 ends a process of performing the processing. Otherwise, the control unit 23 returns to S101.

For example, in the above embodiment, an embodiment can be made in which the configurations and the operations of the information processing device 20 are distributed among a plurality of computers capable of communicating with each other. Also, for example, an embodiment can be made in which part or all of the components of the information processing device 20 are provided in the terminal device 10. For example, the terminal device 10 may include part or all of the components of the information processing device 20.

For example, in the above-described embodiment, the control unit 23 may acquire reactions of the customer to the answer made using the response information, and use the reactions of the customer that are acquired to cause the interactive AI to output further response information directed to the customer, and further send this response information to the terminal device 10 as well. Specifically, the control unit 23 uses natural language processing to extract reactions of the customer from text data, following the salesperson responding to the customer using the response information output by the interactive AI. Next, the control unit 23 uses the reactions of the customer to generate a prompt for input to the interactive AI, which is then input to the interactive AI. The control unit 23 then acquires the response of the interactive AI to the prompt that is input as further response information for the customer. The control unit 23 sends the information output by the interactive AI to the terminal device 10 over the network 30 via the communication unit 21. For example, when a customer asks, "What car model is popular with people around my age group?" and the customer responds in a critical manner to the answer that the salesperson caused the interactive AI to output, the control unit 23 may generate a prompt saying, "The customer is critical about the previous answer. Please present an alternative," and input this prompt to the interactive AI. Note that the control unit 23 may store the reaction of the customer in the storage unit 22.

The control unit 23 may acquire reactions of the customer based on image data of the customer captured by a surveillance camera that is capable of capturing images inside the shop, a camera installed in the terminal device 10, or the like. Specifically, the control unit 23 uses, for example, emotion recognition technology to determine whether reactions of the customer are favorable or critical, based on the image data of the customer.

Also, in the above-described embodiment, a general-purpose computer, for example, can be made to function as the information processing device 20 according to the above-described embodiment. Specifically, a program describing the processing contents for realizing each function of the information processing device 20 according to the above-described embodiment is stored in memory of a general-purpose computer, and the program is read and executed by a processor. Accordingly, the present disclosure can also be realized as a program executable by a processor, or as a non-transitory computer-readable medium that stores the program.

Although the present disclosure has been described based on the drawings and embodiment, it should be noted that those skilled in the art may make various modifications and alterations based on the present disclosure. Accordingly, it should be noted that such modifications and alterations are included within the scope of the present disclosure. For example, the functions and so forth included in the components or the steps and so forth can be rearranged insofar as no logical contradiction arises, and a plurality of components or steps and so forth can be combined into one, or divided.

What is claimed is:

1. An information processing device comprising:
a communication unit that communicates with a terminal device; and
a control unit that performs communication using the communication unit, wherein
the control unit uses a first phrase indicating a request of a customer included in speech of business negotiations with the customer sent from the terminal device, and information of attributes of the customer, to cause an interactive AI to output information for presenting a response to the customer, and sends the information to the terminal device.

2. The information processing device according to claim 1, wherein
the control unit is further configured to
detect the first phrase contained in the speech, using natural language processing,
generate a prompt to be input to the interactive AI using the first phrase and information of attributes of the customer, and
input the prompt to the interactive AI, and cause the interactive AI to output information for presenting the response to the customer.

3. The information processing device according to claim 1, wherein the information of attributes includes at least one of age, gender, and family makeup.

4. The information processing device according to claim 1, wherein
the control unit is further configured to
identify an utterer in the speech using a speaker separation processing, and
acquire the information of attributes, based on utterance of the customer in the speech.

5. The information processing device according to claim 1, wherein
the control unit is further configured to
acquire a reaction of the customer to the response, and
use the reaction to cause the interactive AI to output information to present further response to the customer, and send the information to the terminal device.
